(19) United States
(12) Patent Application Publication
(10) Pub. No.: US 2017/0010243 A1
(43) Pub. Date: Jan. 12, 2017

(54) MULTIPLE COLUMN CHROMATOGRAPHIC SYSTEM AND METHODS OF USE

(71) Applicant: BÜCHI LABORTECHNIK AG, Flawil (CH)

(72) Inventors: Romulus GAITA, Des Plaines, IL (US); Washington MENDOZA, Lake in the Hills, IL (US); Raaidah SAARI-NORDHAUS, Antioch, IL (US); James ANDERSON, Arlington Heights, IL (US); Melissa GOLDE, Rolling Meadows, IL (US)

(21) Appl. No.: 15/117,737

(22) PCT Filed: Feb. 11, 2015
(86) PCT No.: PCT/US15/15469

§ 371 Date: Aug. 10, 2016

Related U.S. Application Data
(60) Provisional application No. 61/938,563, filed on Feb. 11, 2014.

(51) Int. Cl. G01N 30/46; B01D 15/16; G01N 30/64; G01N 30/78; G01N 30/74; B01D 15/18; G01N 30/80

(52) U.S. Cl. CPC G01N 30/468; B01D 15/1864; B01D 15/165; G01N 30/80; G01N 30/78; G01N 30/74; G01N 30/64; G01N 2030/645

(57) ABSTRACT

A chromatographic apparatus includes two chromatographic columns configured to perform chromatography. The apparatus further includes a primary valve disposed upstream of the first chromatographic column and the second chromatographic column. The primary valve selectively switches between a first position in which the pump is in fluid communication with a first path that includes the first chromatographic column and a second position in which the pump is in fluid communication with a second path that includes the second chromatographic column. The apparatus also includes a first and a second sample injection port associated with said first and second columns, respectively, and at least one detector. The apparatus is configured such that flow from the column in the selected path goes to said at least one detector without passing through the other column.

### BACKGROUND

Liquid chromatography systems are used to separate and analyze components of sample mixture. These systems use pumps to pass pressurized solvent and the sample through a column filled with a sorbent which is used to separate components of the sample. Typically a liquid sample passes over a solid adsorbent material packed into a column with a liquid solvent. Different components of the sample interact differently with the adsorbent material. If a component has a weak interaction with the adsorbent material, it flows through the column relatively quickly. If the component has a strong interaction, it flows through the column relatively slowly. Accordingly, different components flow through the column at varying speeds, separating from one another so that they may be analyzed and collected.

Different types of liquid chromatography systems employ different column types that utilize different injection ports. For example, a flash chromatography system typically uses a type of column and a corresponding injection port that are configured for operation under relatively low pressures (0-200 psi). In contrast, a preparative chromatography system uses a type of column and a corresponding injection port that are configured for operation under relatively high pressures (0-5,000 psi).

### SUMMARY

The apparatus and methods described herein provide for selection of a column in a multiple column chromatographic system. In one embodiment, apparatus and methods described herein provide for selectively switching between columns within a multiple column chromatographic system. The types of columns within the multiple column chromatographic system may be configured for operation under the same or different chromatographic conditions.

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

A chromatographic apparatus and an associated method includes a first chromatographic column configured to perform a first type of chromatography as well as a second chromatographic column configured to perform a second type of chromatography. The first type of chromatography and second type of chromatography may be the same or different. In one embodiment, the first type of chromatography to be performed in the first chromatographic column is flash chromatography, and the second type of chromatography to be performed in the second chromatographic column is preparatory chromatography. Other types of chromatography which may be performed in at least one of the first or second chromatographic columns of the multiple column chromatographic system, include, but are not limited to, analytical chromatography, flash chromatography, preparatory chromatography, supercritical fluid chromatography and liquid chromatography.

The apparatus further includes a pump upstream of the columns that is configured to be in selective fluid communication with either the first chromatographic column or the second chromatographic column. A means of switching between the first chromatographic column and the second chromatographic column is disposed upstream of the first chromatographic column and the second chromatographic column and downstream of the pump. In one embodiment, a single multiport primary valve is disposed upstream of the first chromatographic column and the second chromatographic column and downstream of the pump. The primary value may have at least 3 ports. In one embodiment, the primary value has at least 4 ports. In a preferred embodiment, the primary value has from 4 to 16 ports. The primary valve selectively switches between a first position in which the pump is in fluid communication with a first path that includes the first chromatographic column and a second position in which the pump is in fluid communication with a second path that includes the second chromatographic column. Advantageously this single valve switch system provides a much simpler and faster method for switching between columns and/or chromatographic modes than prior art systems which require complex, error-prone multiple configuration changes to achieve the same result.

It is also within the scope of this invention that the means of switching between a first position in which the pump is in fluid communication with a first path that includes the first chromatographic column and a second position in which the pump is in fluid communication with a second path that includes the second chromatographic column is accomplished using two or more valves actuated simultaneously.

The apparatus also includes a first and a second sample injection port associated with said first and second columns, respectively, and at least one detector downstream of said columns. The apparatus is configured such that flow from the column in the selected path goes to said at least one detector without passing through the other column.

### BRIEF DESCRIPTION OF THE DRAWINGS

The following description may be understood when read in conjunction with the appended drawings. For purposes of illustrating the multiple column chromatographic system and methods of use, there is shown in the drawings exemplary constructions of this system and method; however, the system and method is not limited to the specific methods and instrumentalities disclosed. In the drawings:

FIG. 1 is a schematic of an exemplary embodiment of a liquid chromatography system configured to perform flash mode chromatography;

FIG. 2 is a schematic of the exemplary embodiment of a liquid chromatography system shown in FIG. 1 configured to perform preparative mode chromatography;

FIG. 3 is a schematic of as portion of the exemplary embodiment of a chromatography system shown in FIGS. 1 and 2 configured to perform flash mode chromatography;

FIG. 4 is a schematic of a portion of the exemplary embodiment of a liquid chromatography system shown in FIGS. 1-3 configured to perform preparative mode chromatography;

FIG. 5 is a schematic of a portion of the exemplary embodiment of a liquid chromatography system shown in FIGS. 1-4 configured to perform flash mode chromatography;

FIG. 6 is a schematic of a portion of the exemplary embodiment of a liquid chromatography system shown in FIGS. 1-5 configured to perform preparative mode chromatography;

FIG. 7 is a schematic of a portion of the exemplary embodiment of a liquid chromatography system shown in FIGS. 1-6 prior to preparative mode chromatography during sample loading; and

FIG. 8 is a schematic of a portion of the exemplary embodiment of a liquid chromatography system shown in FIGS. 1-7 configured to perform preparative mode chromatography.

### DETAILED DESCRIPTION OF ILLUSTRATIVE EMBODIMENTS

The various aspects of the subject matter described herein are now described with reference to the drawings. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

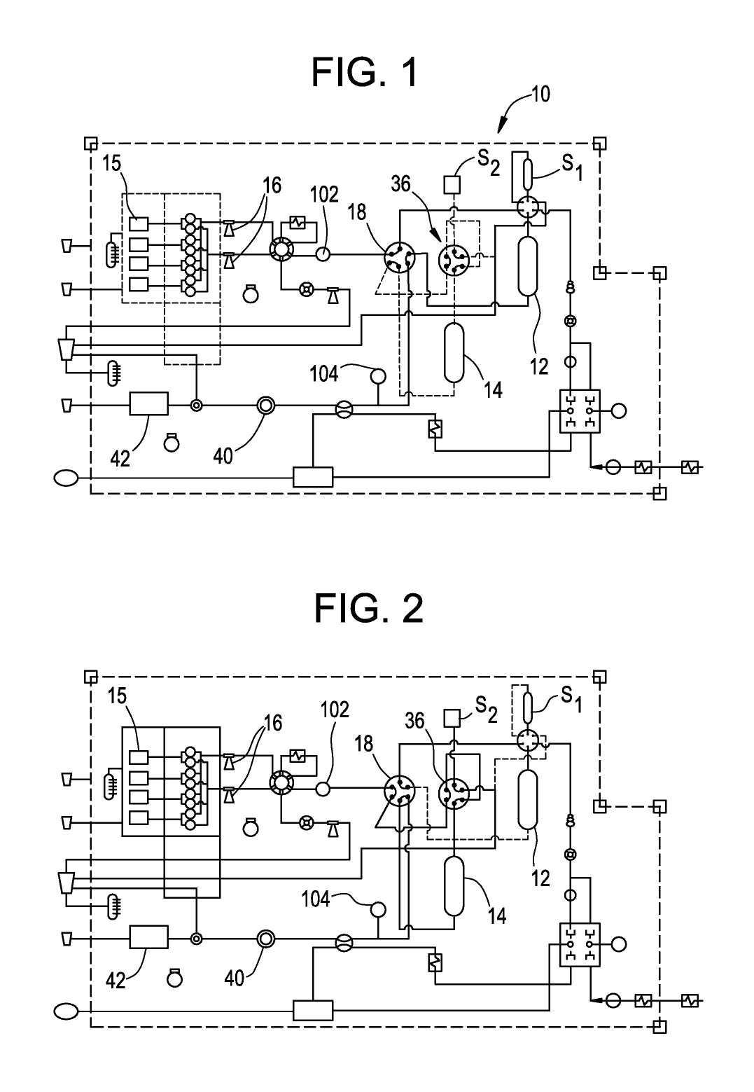

The following description relates to a liquid chromatography apparatus 10 such as that shown in FIG. 1. The chromatographic apparatus 10 includes a first chromatographic column 12 configured to perform flash chromatography as well as a second chromatographic column 14 configured to perform preparative chromatography. The apparatus further includes at least one pump 16 that draws solvent from at least one holding tank 15 for delivery to the columns 12, 14. As shown in FIG. 1, pump 16 is located downstream of holding tanks 15 and upstream of the columns 12, 14. During operation of apparatus 10, pump 16 is configured to be in selective fluid communication with either the first chromatographic column 12 or the second chromatographic column 14.

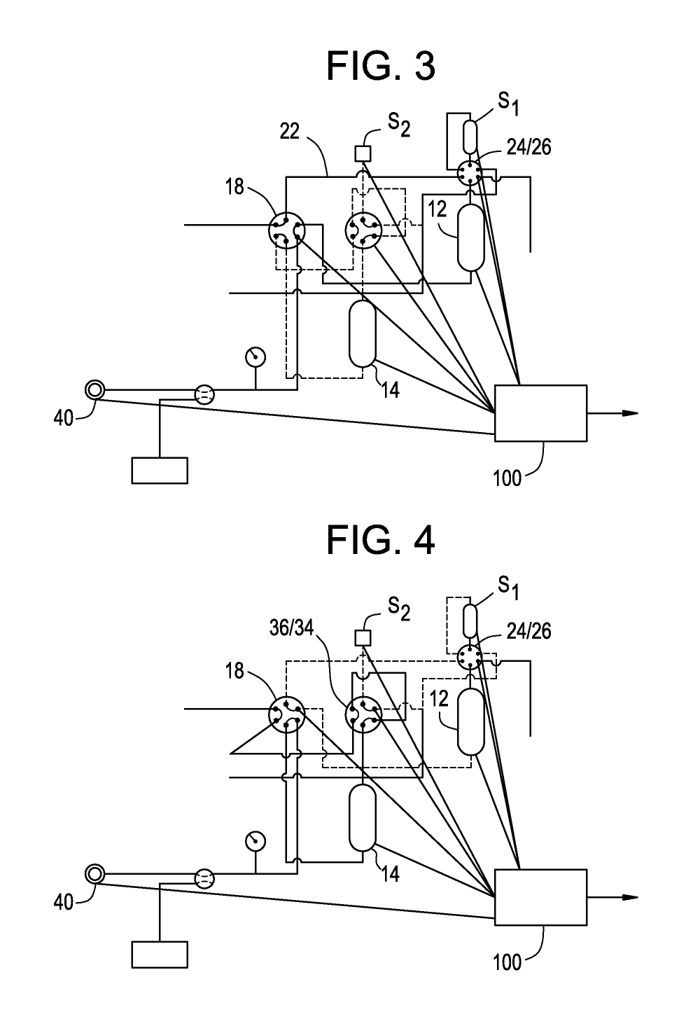

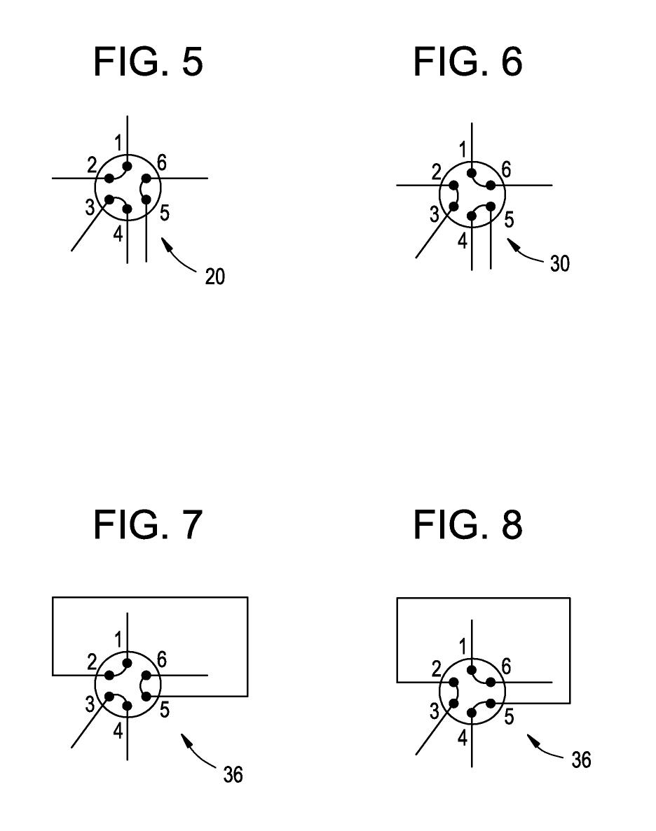

A primary valve 18 is disposed upstream of the first chromatographic column 12 and the second chromatographic column 14 and downstream of the pump 16. The primary valve 18 may be a six-port valve. With reference to FIGS. 3-6, the primary valve 18 selectively switches between a first position and a second position. When the valve is in the first position 20, such as the position shown in FIGS. 3 and 5, the pump 16 is in fluid communication with a first path 22 that includes the first chromatographic column 12. When the valve is in a second position 30, the pump 16 is in fluid communication with a second path 32 that includes the second chromatographic column 14.

The apparatus also includes a first sample injection port 24 associated with the first chromatographic column 12 and a second sample injection port 34 associated with the second chromatographic column 14. Different types of injection ports provide for different types of sample loading into a column. For example, for both of the first and second chromatographic columns 12, 14, a secondary valve may be used for direct injection, solid loading, or both direct injection and solid loading into the column. Such valves may be supplied by Rheodyne (Idex) in Rohnert Park, Calif. or Valco in Houston, Tex.

Each column 12, 14 is in selective fluid communication with a detector 40 and, optionally, a fraction collector 42. Collector 42 may be omitted if the apparatus 10 is intended only for analysis and not collection. Both the detector 40 and the fraction collector 42 are disposed downstream of the first and second chromatographic columns 12, 14. Together, the detector 40 and the fraction collector 42 are configured to analyze and collect at least one fraction of a sample S₁, S₂ that passes through either the first or second path. Specifically, the apparatus is configured such that flow from the column 12 or 14 in the selected path 22 or 32 goes to said at least one detector 40 without passing through the other column 12 or 14, respectively.

### Example 1

### Flash Mode

When the apparatus 10 is in flash mode, the primary valve 18 is in its first position 20 (shown in FIGS. 1, 3, and 5). Solvent is drawn from at least one of the holding tanks 15 by at least one of the pumps 16. Pump 16 pumps the solvent into the primary valve 18. In the first position 20 for primary valve 18, solvent flows from the pump 16 through the first path 22 and into a secondary valve 26.

As shown in FIGS. 1 and 3, secondary valve 26 is a six-port valve that connects the first path 22 with the first column 12 and sample S₁. Secondary valve 26 includes the injection port 24 that is used to inject the sample S₁ into the first column 12. Depending on the position of valve 26, sample S₁ may be injected via a syringe or using a solid loader. When the secondary valve 26 is positioned for loading by the syringe, the sample is injected directly from the syringe through the secondary valve 26 into the first column. When the secondary valve 26 is positioned for solid loading, secondary valve 26 is first primed with solvent by pump 16 and a portion of the sample S₁ is also fed into injection port 24 of the secondary valve 26. Secondary valve 26 then rotates so that the portion of the sample S₁ passes into the first column 12, followed by more solvent from pump 16. While FIGS. 1 and 3 show two ways of depositing the sample S₁, which is a dry sample, into the first column 12, other types of ports 24 and/or valves 26 may be used.

As the sample S₁ flows through the first column 12, different fractions F_{1A}, F_{1B} of the sample interact differently with the adsorbent material. A fraction P_{1A} with a weak interaction with the adsorbent material flows through the first column 12 relatively quickly, while a fraction F_{1B} with a strong interaction flows through the column relatively slowly. Accordingly, fractions F_{1A}, F_{1B}, disposed in solvent, flow from the first column 12 at different times. From the first column 12, these fractions F_{1A}, F_{1B}, along with solvent, are routed back to the primary valve 18 to the detector 40 and collector 42 which ate disposed downstream of the first column 12 and the primary valve 18 when the primary valve is in its first position 20. When the primary valve 18 is in its first position 20, the second column 14 is not in fluid communication with either the pump 16 or the detector 40 and collector 42.

Detector 40 may be a non-destructive detector such an ultraviolet light detector, an optical absorbance detector, a refractive index detector (RID), a fluorescence detector (FC), chiral detector (CD), or a conductivity detector. Other types of detectors, including destructive detectors, may be used instead of or in addition to a non-destructive detector. For example, an evaporative light scattering detector, a mass spectrometer (MS), a condensation nucleation light scattering detector (CNLSD), and a corona discharge detector. Multiple non-destructive and/or destructive detectors may be used in apparatus 10. Destructive detectors may be used in conjunction with a shuttle valve such that only a portion of the sample is removed from the sample stream and destroyed.

### Example 2

### Preparative Mode

When the apparatus 10 is in preparative mode, the primary valve 18 is in its second position 30 (shown in FIGS. 2, 4, and 6). Solvent is drawn from at least one of the holding tanks 15 by at least one of the pumps 16. Pump 16 pumps the solvent into the primary valve 18. In the second position 30 for primary valve 18, solvent flows from the pump 16 through the second path 32 and into a secondary valve 36.

As shown in FIGS. 2, 4, 7, and 8, secondary valve 36 is a six-port valve that connects the second path 32 with the second column 14 and sample S₂. Secondary valve 36 includes the injection port 34 that is used to inject the sample S₂ into the second column 14. Specifically, as shown in FIG. 7, secondary valve 36 is first primed with solvent by pump 16 and a portion of the sample is also fed into injection port 34 of the secondary valve 36. With reference to FIG. 8, secondary valve 36 then rotates so that the portion of the sample S₂ passes into the second column 14, followed by more solvent from pump 16. While FIGS. 2, 4, 7, and 8 show one way of depositing the sample S₂, into the second column 14, other types of ports 34 and/or valves 36 may be used.

Similar to the process described above, as the sample S₂ through the second column 14, different fractions F_{2A}, F_{2B} of the sample interact differently with the adsorbent material. A fraction F_{2A} with a weak interaction with the adsorbent material flows through the second column 14 relatively quickly, while a fraction F_{2A}, F_{2B} with a strong interaction flows through the column relatively slowly. Accordingly, fractions F_{2A}, F_{2B}, disposed in solvent, flow from the second column 14 at afferent times. From the second column 14, these fractions F_{2A}, F_{2B}, along with solvent, are routed back to the primary valve 18 to the detector 40 and collector 42 which are disposed downstream of the second column 14 and the primary valve 18 when the primary valve is in its second position 30. Detector 40 and collector 42 are more fully described in relation to Example 1. When the primary valve 18 is in its second position 30, the first column 12 is not in fluid communication with either the pump 16 or the detector 40 and collector 42.

Primary valve 18 may be configured to switch between the first position 20 and the second position 30 in various ways. For example, primary valve 18 may be manually actuated between positions 20, 30. Alternatively, primary valve 18 may be automatically actuated using a control system 100.

Control system 100 includes sensors disposed throughout apparatus 10 that are configured to identify and set the position of primary valve 18. For example, control system 100 uses sensors configured to read RFID tags or bar codes on columns 12, 14. Other identification tags may also be used, such as QR codes. In conjunction with the sensors, control system 100 can determine whether a flash or preparative column is installed in the apparatus and the operating parameters associated with an installed column. Control system 100 may connect to a network, such as the internet, to determine operating parameters associated with the installed column. The network may also be used to control the apparatus 10 remotely and/or to report results of a run. Control system 100 may also include a user interface (not shown) to display operating parameters of the system and to accept user input regarding whether to process a sample using flash or preparative modes.

Optionally, with reference to U.S. Application No. 61/938,508 filed Feb. 11, 2014, which is hereby incorporated in its entirety herein, control system 100 be used to control other aspects of apparatus 10. For example, the positions of secondary valves 26, 36, may be controlled using sensors to determine if the secondary valves 26, 36 have been sufficiently primed with solvent and a sample S₁, S₂. Operating speed of pump 16 may also be controlled based on readings from pressure sensors 102, 104.

As the foregoing illustrates, the present invention is directed to a multiple column chromatographic system and methods of use. Changes may be made to the embodiments described above without departing from the broad inventive concepts thereof. Accordingly, the present invention is not limited to the particular embodiments disclosed, but is intended to cover all modifications that are within the spirit and scope of the invention as defined by the appended claims.

What is claimed:

1. A chromatographic apparatus comprising:
a first chromatographic column configured to perform a first type of chromatography;
a second chromatographic column configured to perform a second type of chromatography;
a pump configured to be in selective fluid communication with either the first chromatographic column or the second chromatographic column, the pump being upstream of the columns;
a primary valve disposed upstream of the first chromatographic column and the second chromatographic column and downstream of the pump, the primary valve configured to selectively switch between
a first position in which the pump is in fluid communication with a first path that includes the first chromatographic column; and
a second position in which the pump is in fluid communication with a second path that includes the second chromatographic column;
a first and a second sample injection port associated with said first and second columns, respectively; and
at least one detector downstream of said columns;
wherein the apparatus is configured such that flow from the column in the selected path goes to said at least one detector without passing through the other column.

2. The chromatographic apparatus of claim wherein the first chromatographic column is configured to perform flash chromatography and the second chromatographic column is configured to perform preparative chromatography.

3. The chromatographic apparatus of claim 1, further comprising a fraction collector configured to collect at least one fraction from either the first or second path.

4. The chromatographic apparatus of claim 1 wherein the first sample injection port is configured for direct injection, solid loading, or both direct injection and solid loading of a sample into the first chromatographic column.

5. The chromatographic apparatus of claim 4 wherein the first path further comprises a secondary valve configured to provide for direct injection, solid loading, or both direct injection and solid loading of the sample into the first chromatographic column.

6. The chromatographic apparatus of claim 1 wherein the second sample injection port is configured such that solvent continuously flows from the pump as a sample flows into the second chromatographic column.

7. The chromatographic apparatus of claim 6 wherein the second path further comprises a secondary valve configured such that solvent continuously flows from the pump as a sample flows into the second chromatographic column

8. The chromatographic apparatus of claim 1 wherein the primary valve is a six-port valve.

9. The chromatographic apparatus of claim 1 wherein the columns comprise identifying information and the apparatus further comprises means for identifying installed columns based on the identifying information on the columns.

10. The chromatographic apparatus of claim 9 wherein the identifying information includes an RFID tag.

11. The chromatographic apparatus of claim 9 wherein the identifying information includes a bar code.

12. The chromatographic apparatus of claim 9 wherein the primary valve is automatically actuated between the first position and the second position based on identity of the installed columns.

13. The chromatographic apparatus of claim 1 wherein the primary valve is configured to be manually actuated between the first position and the second position.

14. The chromatographic apparatus of claim 1 further comprising at least one of a non-destructive detector and a destructive detector.

15. The chromatographic apparatus of claim 14 comprising a non-destructive detector that is an ultraviolet light detector.

16. The chromatographic apparatus of claim 14 comprising a non-destructive detector selected from the group consisting of optical absorbance detectors, refractive index detectors (RID), fluorescence detectors (FD), chiral detectors (CD), and conductivity detectors.

17. The chromatographic apparatus of claim 14 comprising a destructive detector that is an evaporative light scattering detector.

18. The chromatographic apparatus of claim 14 comprising a destructive detector selected from the group consisting of evaporative light scattering detectors (ELSD), mass spectrometers (MS), condensation nucleation light scattering detectors (CNLSD), and corona discharge detectors.

19. A chromatographic apparatus comprising:
a first chromatographic column configured to perform flash chromatography;
a second chromatographic column configured to perform preparative chromatography;
a pump configured to be in selective fluid communication with either the first chromatographic column or the second chromatographic column, the pump being upstream of the columns;
a primary valve disposed upstream of the first chromatographic column and the second chromatographic column and downstream of the pump, the primary valve configured to selectively switch between
a first position in which the pump is in fluid communication with a first path, the first path including the first chromatographic column, said first chromatographic column having associated therewith a first sample injection port configured for direct injection, solid loading, or both direct injection and solid loading of a sample into the first chromatographic column; and
a second position in which the pump is in fluid communication with a second path, the second path including the second chromatographic column, said second chromatographic column having associated therewith a secondary valve having a second sample injection port configured to provide for continuous solvent flow from the pump as a sample flows into the second chromatographic column;
at least one non-destructive detector and at least one destructive detector downstream of said columns; and
a fraction collector configured to collect at least one fraction from either the first or second path;
wherein the apparatus is configured such that flow from the column in the selected path does not flow through the other column, and
wherein the columns comprise identifying information and the apparatus further comprises means for identifying installed columns based on the identifying information on the columns.

20. A method of performing chromatography using a chromatography system having a first chromatographic column configured to perform a first type of chromatography; a second chromatographic column configured to perform a second type of chromatography; a pump configured to be in selective fluid communication with either the first chromatographic column or the second chromatographic column, the pump being upstream of the columns; a primary valve disposed upstream of the first chromatographic column and the second chromatographic column and downstream of the pump, the primary valve configured to selectively switch between
a first position in which the pump is in fluid communication with a first path that includes the first chromatographic column; and a second position in which the pump is in fluid communication with a second path that includes the second chromatographic column; a first and second sample injection port associated with said first and second columns, respectively; and at least one detector downstream of said columns, the steps comprising:
selecting either the first flow path or the second flow path to process a sample stream;
directing the sample stream through the selected sample injection port;
actuating the pump such that the sample stream passes through the selected chromatographic column; and
flowing the sample stream to said at least one detector without passing through the other chromatographic column.

21. The method of claim 20, wherein the first chromatographic column is configured to perform flash chromatography and the second chromatographic column is configured to perform preparative chromatography.

22. The method of claim 20, wherein the chromatography system further comprises a fraction collector configured to collect at least one fraction from either the first or second path.

23. The method of claim 20, wherein the flowing step comprises flowing said sample stream to said at least one detector without flowing said sample stream through the unselected chromatographic column.

24. The method of claim 20 wherein the directing step includes direct injection or solid loading of the sample stream into the first chromatographic column.

75. The method of claim 20 wherein the directing step includes continuously flowing solvent from the pump as the sample stream flows into the second chromatographic column.

26. The method of claim 20 wherein the primary valve is a six-port valve.

27. The method of claim 20 wherein the selecting step is performed by means in the system for identifying installed columns based on identifying information on the columns.

28. The method of claim 27 wherein the means include an RFID tag.

29. The method of claim 27 wherein the means include a bar code.

30. The method of claim 27 wherein the selecting step comprises automatically actuating between the first position and the second position based on identity of the installed columns.

31. The method of claim 20 wherein the selectin. step includes is manually actuating the primary valve from the first position and the second position.

32. The method of claim 20 further comprising at least one of a non-destructive detector and a destructive detector.

33. The method of claim 32 comprising a non-destructive detector that is an ultraviolet light detector.

34. The method of claim 32 comprising a non-destructive detector selected from the group consisting of optical absorbance detectors, refractive index detectors (RID), fluorescence detectors (FD), chiral detectors (CD), and conductivity detectors.

35. The method of claim 32 comprising a destructive detector that is an evaporative light scattering detector.

36. The method of claim 32 comprising a destructive detector selected from the group consisting of evaporative light scattering detectors (ELSD), mass spectrometers (MS), condensation nucleation light scattering detectors (CNLSD), and corona discharge detectors.

37. A method of performing chromatography using a chromatography system laving a first chromatographic column configured to perform flash chromatography; a second chromatographic column configured to perform preparative chromatography; a pump configured to be in selective fluid communication with either the first chromatographic column or the second chromatographic column, the pump being upstream of the columns; a primary valve disposed upstream of the first chromatographic column and the second chromatographic column and downstream of the pump, the primary valve configured to selectively switch between a first position in which the pump is in fluid communication with a first path, the first path including a the first chromatographic column, said first chromatographic column having associated therewith a first sample injection port configured for direct injection, solid loading, or both direct injection and solid loading of a sample into the first chromatographic column; and a second position in which the pump is in fluid communication with a second path, the second path having associated therewith a secondary valve having a second sample injection port configured to provide for continuous solvent flow from the pump as a sample flows into the second chromatographic column; at least one non-destructive detector and at least one destructive detector downstream of said columns; and a fraction collector configured to collect at least one fraction from either the first or second path, the steps comprising:
selecting either the first flow path or the second flow path to process a sample stream, the selecting step being performed by means in the system for identifying installed columns based on identifying information on the columns;
directing the sample stream through the selected sample injection port;
actuating the pump such that the sample stream passes through the selected chromatographic column; and
flowing the sample stream to said at least one of a non-destructive detector and a destructive detector without passing through the other chromatographic column.
